(19) United States
(12) Patent Application Publication
(10) Pub. No.: US 2016/0028162 A1
(43) Pub. Date: Jan. 28, 2016

(54) CAVITY-BACKED PATCH ANTENNA

(71) Applicant: QUALCOMM Incorporated, San Diego, CA (US)

(72) Inventors: Yu-Chin Ou, San Diego, CA (US); Mohammad Ali Tassoudji, San Diego, CA (US); Haim Mendel Weissman, Haifa (IL); Lior Raviv, Atlit (IL)

(21) Appl. No.: 14/444,118

(22) Filed: Jul. 28, 2014

(51) Int. Cl. H01Q 9/04

(52) U.S. Cl. CPC H01Q 9/0457

(57) ABSTRACT

Disclosed is a wideband antenna comprising a dielectric-loaded cavity-backed patch antenna driven with a stripline. The antenna includes a dielectric resonator. The stripline feeds a probe disposed within the dielectric resonator. The probe emits EM radiation, which is coupled to the patch antenna for transmission.

### BACKGROUND

Unless otherwise indicated, the foregoing is not admitted to be prior art to the claims recited herein and should not be construed as such.

Conventionally, millimeter wave applications use a wide-band patch antenna configured with a stripline. Wide-band patch antennas are typically made from a low dielectric (∈ᵣ=2.2) material and provided over a relatively thick substrate. This thickness tends to set up surface waves at mm frequencies, resulting in poor radiating performance. Also, when the patch antenna and stripline are made separately and then combined together, the overall substrate is too thick to include any other types of antennas, for example dipoles, in the same stack-up. Alternate antenna structures can be integrated with a stripline, but do not perform well due to non-ideal parallel plate modes.

### SUMMARY

An antenna in accordance with embodiments of the present disclosure include a stripline that feeds a patch antenna. The stripline may include a ceramic substrate that defines a dielectric resonator cavity within it. A perimeter of the dielectric resonator cavity may be defined by a substrate integrated waveguide (SIW) and an electromagnetic (EM) probe disposed within the SIW. First and second ground planes disposed above and below the SIW further define the perimeter of the dielectric resonator. A signal line feeds the EM probe, which emits EM radiation (radio waves) that are coupled to the patch antenna for transmission by the patch antenna.

In embodiments, the antenna further includes a patch substrate spaced apart from the ceramic substrate of the stripline by the first ground plane. The patch substrate may support the patch antenna.

In embodiments, the first ground plane may include a cut-out portion to provide a radio transparent path between the EM probe and the patch antenna.

In some embodiments, the patch antenna comprises several conductive strips.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, make apparent to those of skill in the art how embodiments in accordance with the present disclosure may be practiced. In the accompanying drawings:

FIG. 1 shows a top view of an illustrative antenna in accordance with the present disclosure.

FIGS. 1A, 1A-1, 1B and 1C illustrate side views of the antenna shown in FIG. 1.

FIGS. 2A-2D illustrate various dimensions in accordance with a particular embodiment of an antenna in accordance with the present disclosure.

FIG. 3 shows a perspective view of an antenna of the present disclosure.

FIG. 4 illustrates an antenna array.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

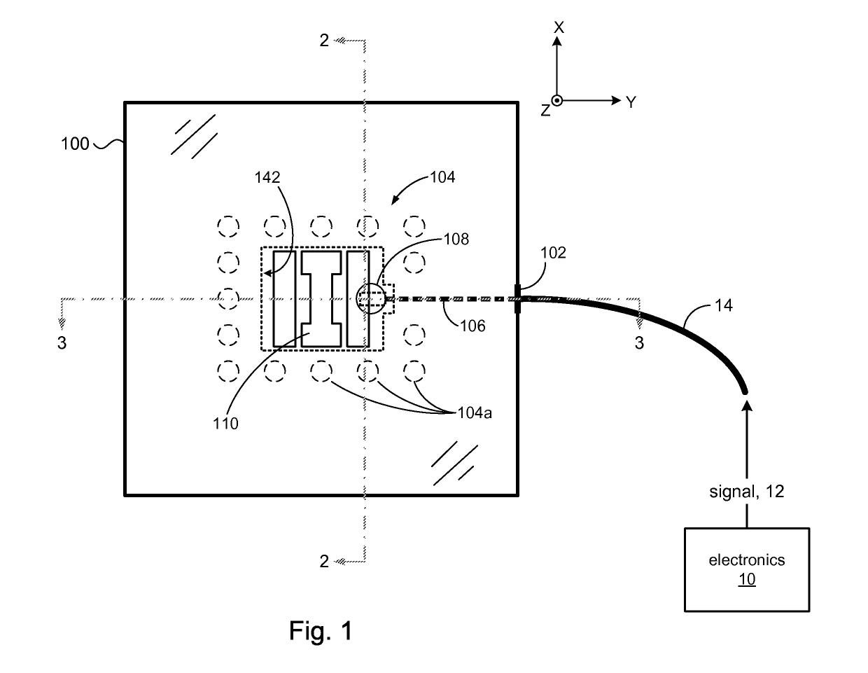

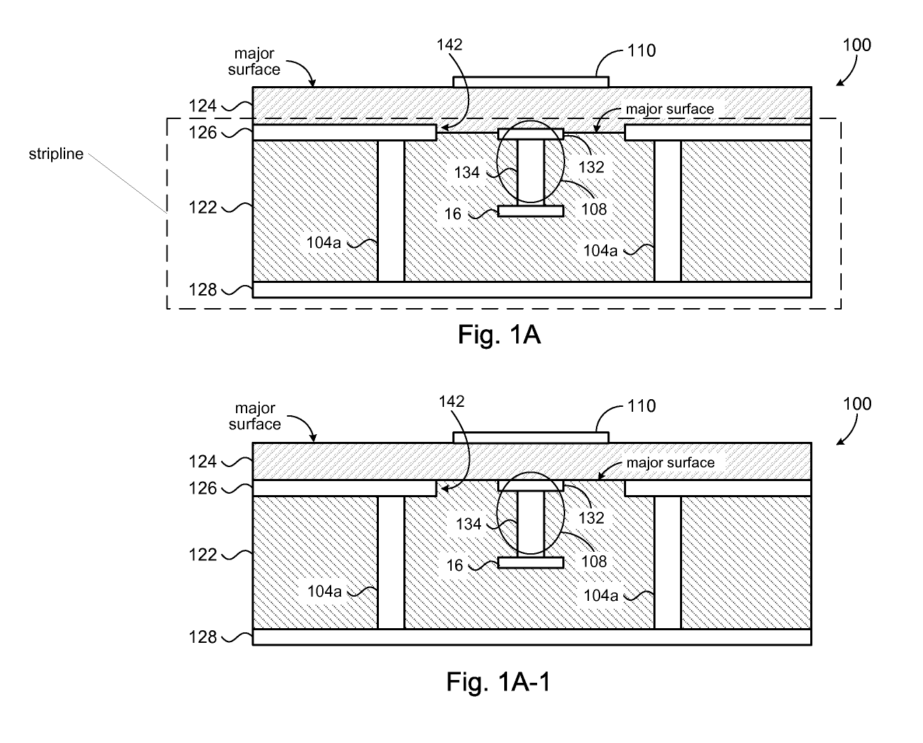

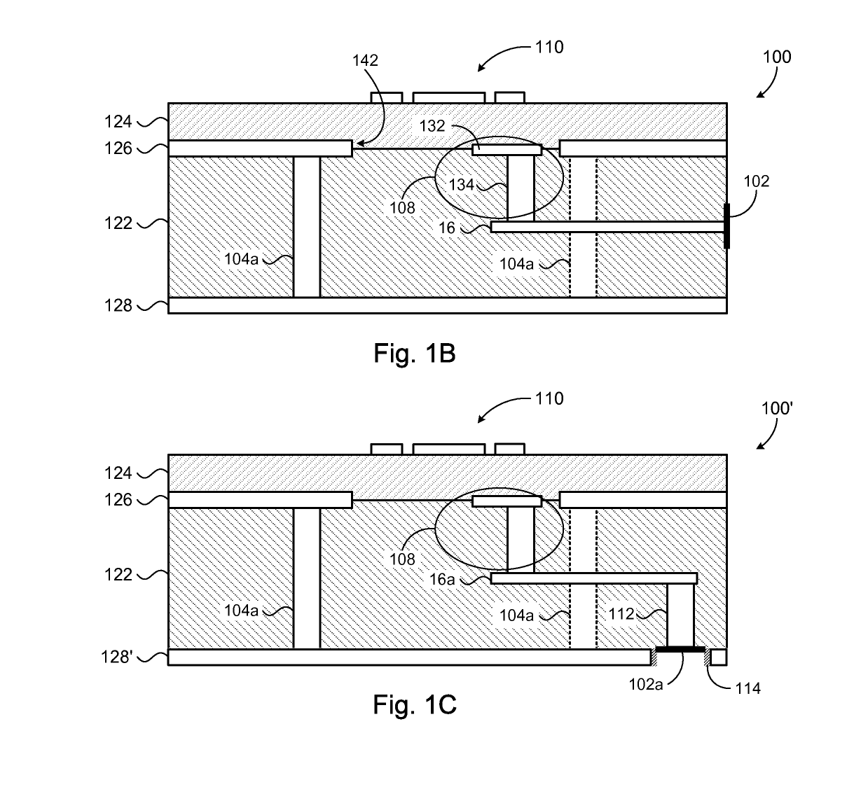

FIG. 1 shows a top view of an antenna 100 in accordance with embodiments of the present disclosure. A coordinate system illustrates the X, Y, and Z directions for discussion purposes. The Z-axis is the axis perpendicular to the drawing sheet.

The antenna 100 may include a suitable connection interface 102 for connecting to a feedline 14 to receive an externally generated signal 12. The signal 12, which may be generated by electronics 10, can be provided to the feedline 14 for transmission by the antenna 100. Merely as an example, the electronics 10 may be the transmitting electronics in a cellular telephone, a laptop computer, etc.

The antenna 100 may be a multilayered structure. Various structures may be formed or otherwise embedded in the several layers of the multilayered structure of antenna 100. A substrate integrated waveguide (SIW) cavity 104 may be defined within one of the layers of the antenna. In some embodiments, for example, the SIW cavity 104 may be defined by an array of vias 104a formed in the layer.

The antenna 100 may include a signal line 106 that is connected to the connection interface 102. An electromagnetic (EM) probe 108 may be connected to the other end of signal line 106. The EM probe 108 may be exposed through an open region (cut out) 142 in one of the layers of the antenna 100.

In accordance with the present disclosure, the antenna 100 may include a patch antenna 110 disposed atop the multilayered structure of the antenna. In some embodiments, the patch antenna 110 may comprise several conductive strips, such as illustrated in the figure. The conductive strips may be separate, or they may be connected. In other embodiments, the patch antenna 110 may comprise a single piece of conductive material.

FIG. 1 shows some view lines 2-2 and 3-3. The view line 2-2 is used to show a cutaway view of antenna 100, looking in the Y direction. Likewise, the view line 3-3 is used to show a cutaway view of antenna 100 looking in the X direction. The cutaway views show additional details of the structure of the antenna 100, which will now be described.

FIG. 1A illustrates a cutaway view of antenna 100 along view line 2-2, showing additional details of the antenna's multilayered structure and the various structures disposed on the several layers. In some embodiments, the multilayered structure may comprise a first substrate 122 and a second substrate 124. A first ground plane (metal layer, conductive layer) 126 may be disposed between the first and second substrates 122, 124. A second ground plane 128 may be disposed on the first substrate 122 opposite the first ground plane 126.

The first ground plane 126 may include an opening or cut-out 142 where portions of the first and second substrates 122, 124 contact each other. In some embodiments, the first and second substrates 122, 124 may both include recessed portions to accommodate the first ground plane 126, such as illustrated in FIG. 1A. In some embodiments, the first ground plane 126 may be received in a recessed portion of the first substrate 122, such as illustrated in FIG. 1A-1 for example. In other embodiments, the first ground plane 126 may be received in a recessed portion of the second substrate 124 (not shown).

The first substrate 122 may have embedded within it the signal line 16, the SIW cavity 104, the EM probe 108. The vias 140a comprising the SIW cavity 104 may be formed through the first substrate 122. In some embodiments, the vias 104a may extend from the first ground plane 126 to the second ground plane 128.

The EM probe 108 may comprise a pad 132 and a via 134. The pad 132 may be disposed on or near a major surface of the first substrate 122. FIG. 1A, for example, shows the pad 132 extends slightly beyond a major surface of the first substrate 122. In another embodiment, the pad 132 may be disposed substantially flush with a major surface of the first substrate 122, such a illustrated in FIG. 1A-1 for example.

The via 134 may be formed in the first substrate 122, extending from the pad 132 to the signal line 16. The via 134 may contain a conductive material to provide an electrical connection between the pad 132 and the signal line 16. In some embodiments, the structures encompassed by the boxed region shown in dashed lines in FIG. 1A may be referred to as a “stripline.”

The second substrate 124 may support or otherwise carry the patch antenna 110 on a major surface of the second substrate, and thus may be referred to as the “patch substrate.” In accordance with the present disclosure, the patch antenna 110 may be spaced apart from the EM probe 108 by the patch substrate 124. Accordingly, the patch antenna 110 is not electrically connected to the signal line 16 or to the pad 132 of EM probe 108.

FIG. 1B illustrates a cutaway view of antenna 100 showing additional details of the antenna's multilayered structure and the various structures along view line 3-3. As shown in FIG. 1B, in some embodiments, the connection interface 102 may be located on a side of the antenna 100. In other embodiments, the connection interface 102 may be located elsewhere. FIG. 1C, for example, shows a connection interface 102a disposed on a bottom of the antenna. The second ground plane 128′ may include an opening to accommodate the connection interface 102a. An insulative layer 114 may electrically insulate the connection interface 102a from the second ground plane 128′. A via 112 may provide an electrical connection from the connection interface 102a to signal line 16a.

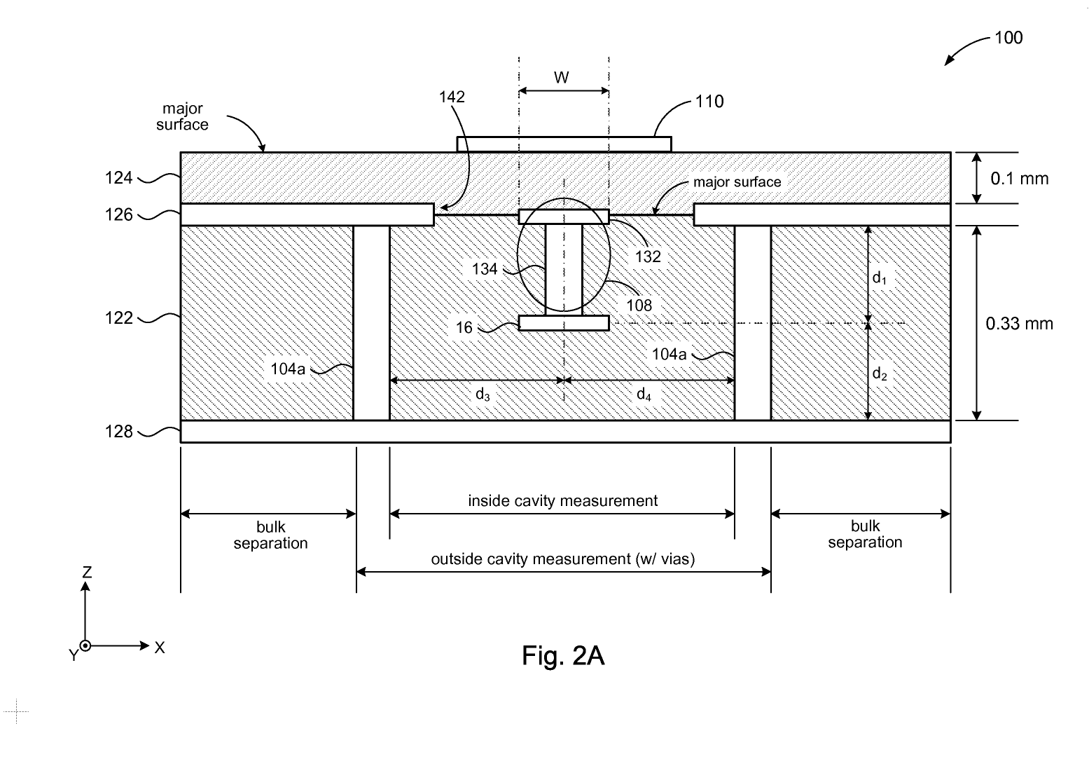

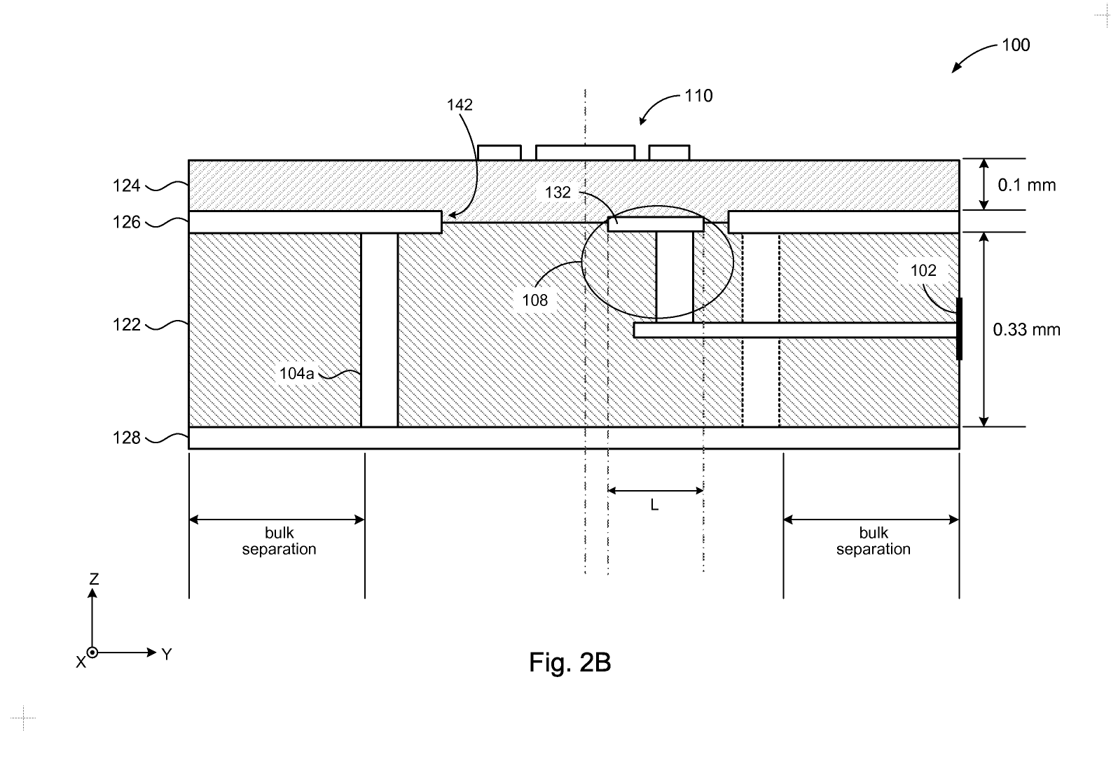

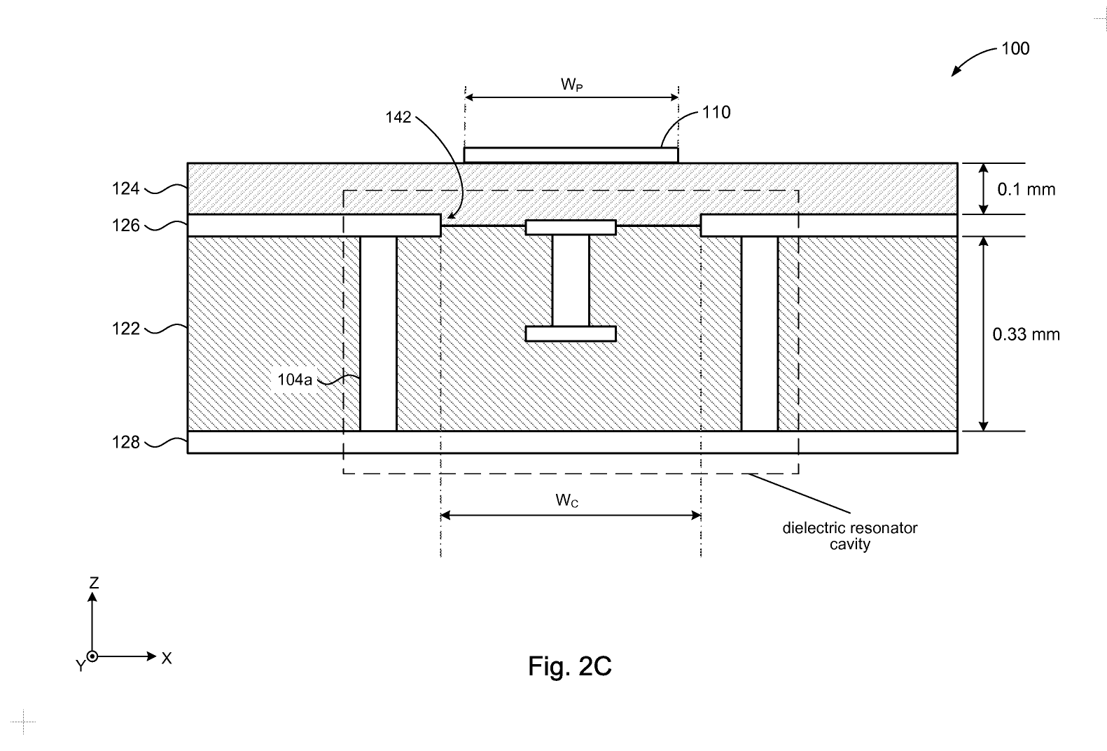

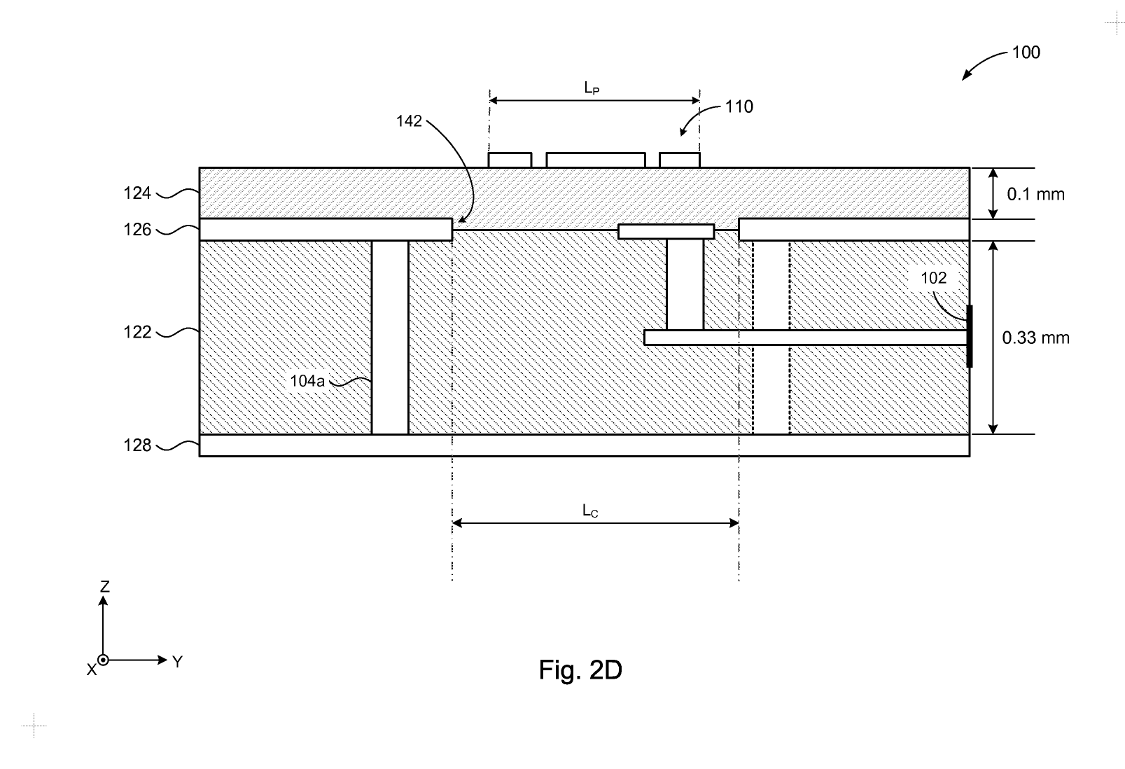

FIGS. 2A and 2B show a typical illustrative embodiment of the antenna 100 of the present disclosure, viewed along view line 2-2 (FIG. 2A) and along view line 3-3 (FIG. 2B). The relative dimensions between the structures have been exaggerated to facilitate the illustration. The specific dimensions may depend on factors such as intended environment that the antenna 100 may be exposed to, operating frequency range, materials used, specific designs (e.g., the patch antenna 110, EM probe 108, etc.).

In a particular embodiment, for example, the first substrate 122 may be a ceramic material having a thickness of about 0.33 mm as illustrated in FIG. 2A. The second substrate 124 may be ceramic having a thickness of about 0.1 mm. The ceramic material may have a dielectric constant ∈ᵣ=6.7 and a dielectric loss tangent of 0.005. It will be appreciated of course that these parameters may vary depending on design, choice of material, and so on.

In some embodiments, the first substrate 122 and the second substrate 124 may be the same ceramic. In other embodiments, the first and second substrates 122, 124, may be of different ceramic materials. In still other embodiments, materials other than ceramics may be used. In a particular embodiment, however, it may be desirable to use ceramic. The use of ceramics allows for a well known process called low temperature co-fired ceramics (LTCC), which allows for the structures of the antenna 100 to formed in the same process.

The SIW cavity 104 may be measured according to its inside cavity measurements as illustrated in FIG. 2A. In a particular embodiment, for example, the SIW cavity 104 may have inside measurements of 1.3 mm×1.6 mm. Alternatively, the SIW cavity 104 may be measured according to its outside cavity measurements, also illustrated in FIG. 2A. In a particular embodiment, for example, the outside measurement may be 1.65 mm×1.95 mm. It will be appreciated of course that in other embodiments, the SIW cavity 104 can be any suitable size to accommodate other designs. In some embodiments, the vias 104a that define the SIW cavity 104 may be arranged to form other shapes such a square, circle, etc.

In some embodiments, the SIW cavity 104 may be centered within the bulk of the first substrate 124. Referring to FIGS. 2A and 2B, the bulk separation between the outer periphery of the SIW cavity 104 and the outer periphery of the first substrate 122 can be on the order of many millimeters.

In some embodiments, the signal line 16 may be disposed within the first substrate 122 substantially equidistant from the first ground plane 126 and the second ground plane 128. FIG. 2A, for example, shows separation distances d₁ and d₂, where d₁ is substantially equal to d₂. In addition, the signal line 16, as well as the EM probe 108, may be positioned along the X-axis substantially in the middle of the SIW cavity 104; e.g., distance d₃ is substantially equal to d₄.

Referring to FIGS. 2A and 2B, the pad 132 may be substantially as wide (width, W) as the signal line 16, and may have a length dimension L. In a particular implementation, for example, the pad 132 was designed with 0.1 mm (W)×0.45 mm (L). It will be appreciated that, in general, the dimensions for pad 132 are a design factor; for example, to optimize performance.

In various embodiments, the EM probe 108 may be positioned along the Y-axis as shown in FIG. 2B. However, for practical design purposes, the EM probe 108 may be offset in the X-axis direction; for example, to accommodate for an asymmetrical feed. Similarly, in various embodiments, the position of pad 132 may likewise be along the Y-axis, and may include an X-axis offset.

Referring to FIGS. 2C and 2D, in some embodiments, the dimensions of the patch antenna 110 and the dimensions of the cut-out 142 may be determined by the desired operating frequency of the antenna 100. The operating frequency defines the working wavelength. This, in turn, controls the dimensions of the patch antenna 110 (W_{P}×L_{P}) and the dimensions of the cut-out 142 (W_{C}×L_{C}).

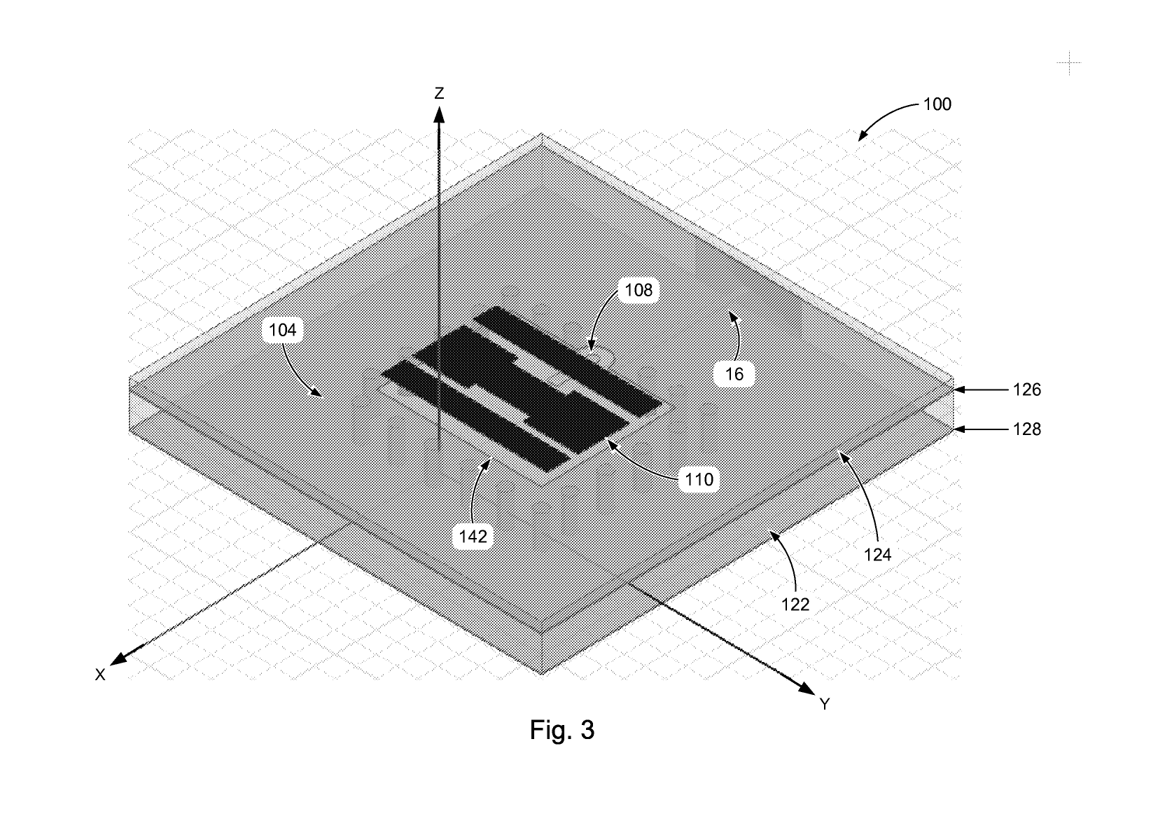

FIG. 3 shows a perspective view of an embodiment of antenna 100 in accordance with the present disclosure. The figure illustrates relative positions of the various structures described above.

In operation, the SIW cavity 104 embedded within the ceramic material of the first substrate 122 and bounded by the first and second ground planes 126, 128 define a dielectric resonator cavity (FIG. 2C). The symmetrical arrangement of the signal line 16 and the EM probe 108 described above can facilitate resonance of radio waves within the dielectric resonator cavity.

Radio waves may be introduced into the cavity from the EM probe 108. When the dimensions of the SIW cavity 104 are designed to the frequency range of the radio waves, the radio waves will bounce back and forth (resonate) between the walls of the resonator cavity, namely the vias 104a of the SIW cavity 104 and the first and second ground planes 126, 128, to form standing waves. The opening 142 in the first ground plane 126 is transparent to the radio waves (radio transparent), allowing radio power to radiate from the resonator cavity and couple to the patch antenna 110.

An advantageous aspect of the antenna 100 is that the dielectric loaded SIW cavity 104 formed beneath the patch antenna 110 supports wide-band and unidirectional radiation, while at the same time suppressing surface wave modes that would degrade overall performance. By incorporating the SIW cavity 104 within the structure of the antenna 100, an antenna array can be configured with low mutual coupling between antennas. Antennas according to the present disclosure are therefore very suitable for wide-angle scanning array applications.

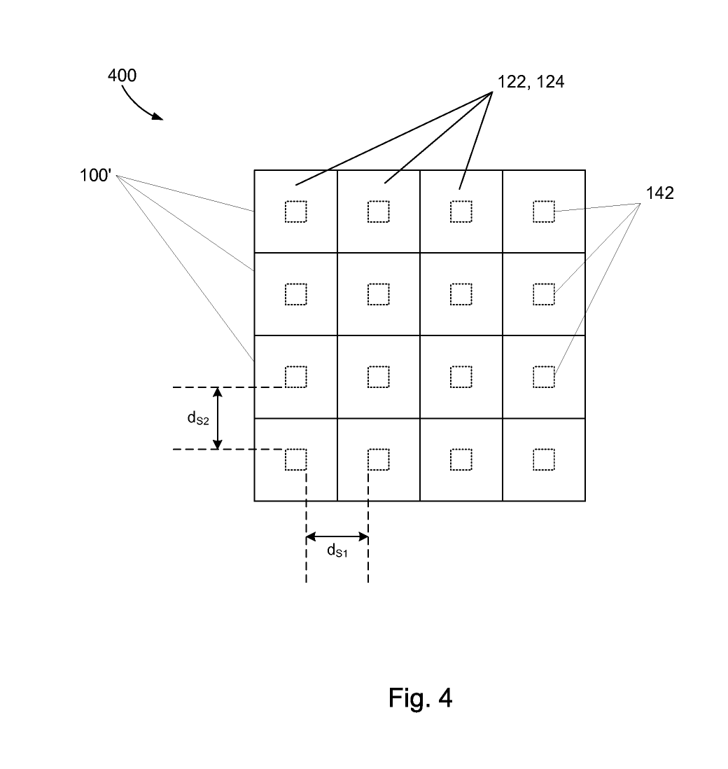

FIG. 4, for example, shows an antenna array 400 comprising an array of antennas 100′ (FIG. 1C). The antenna array 400 may use the antenna embodiment of FIG. 1C, where the connection interface 102′ is provided on the bottom surface of each antenna 100′ to facilitate connecting feedlines to the antennas. As can be seen in FIG. 4, dimensions of the first and second substrates 122, 124 of the antennas 100′ can be selected to ensure that the dielectric resonator cavities (represented by the cut-out regions 142) of the antennas 100′ are sufficiently spaced apart (d_{S1}, d_{S2}) from each other so as to reduce mutual coupling between the dielectric resonator cavities. In some embodiments, the dimensions of each antenna 100′ may be designed so that d_{S1} is substantially equal to d_{S2}. In other embodiments, d_{S1} may be different from d_{S2}. In still other embodiments, the separations d_{S1}, d_{S2} between dielectric resonator cavities may vary across the array 400.

In a particular implementation of the antenna 100, using ceramic material having a dielectric constant of ∈ᵣ=6.7, the following observations were noted:
wide impedance bandwidth: 15% fractional bandwidth (FBW) for S11<10 dB
flat gain bandwidth: <2 dB variation within 57-66 GHz
substantially constant radiation patterns

Antennas in accordance with the present disclosure are compact and have a planar geometry that is suitable for conventional printed circuit board (PCB) and LTCC processes. Antennas in accordance with the present disclosure can be designed for mm wave applications (e.g., 60 GHz), but can be easily scaled for other frequencies.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

We claim the following:

1. An antenna comprising:
a first substrate;
a signal line disposed within the first substrate;
an electromagnetic (EM) probe disposed within the first substrate and connected to the signal line;
a first ground plane disposed on a first major surface of the first substrate and having a cut-out portion, the EM probe aligned with the cut-out portion and exposed through the cut-out portion;
a second substrate disposed on the first ground plane; and
at least one conductive strip disposed on the second substrate and spaced apart from the EM probe.

2. The antenna of claim 1 wherein the first substrate further comprises a substrate integrated waveguide (SIW) cavity.

3. The antenna of claim 2 wherein the SIW cavity comprises a plurality of vias disposed in the first substrate and arranged about the cut-out portion of the first ground plane.

4. The antenna of claim 2 wherein the SIW cavity defines a dielectric resonator cavity.

5. The antenna of claim 1 comprising a plurality of conductive strips, wherein each conductive strip is electrically disconnected from the other conductive strips.

6. The antenna of claim 1 wherein the at least one conductive strip is electrically disconnected from the signal line.

7. The antenna of claim 1 wherein the at least one conductive strip is spaced apart from the EM probe by a distance substantially equal to a thickness of the second substrate.

8. The antenna of claim 1 wherein the EM probe comprises a conductive pad connected to a conductive via formed in the first substrate, the conductive via connected to the signal line.

9. The antenna of claim 8 wherein the conductive pad is approximately coplanar with the first ground plane.

10. The antenna of claim 1 further comprising a second ground plane disposed on a second major surface of the first substrate, the signal line positioned substantially equidistant from the first ground plane and the second ground plane.

11. An antenna comprising:
a stripline comprising a first substrate, first and second ground planes disposed on respective first and second major surfaces of the first substrate, a signal line disposed within the first substrate, and a probe disposed within the first substrate and connected to the signal line, the first ground plane having a cut-out portion in alignment with the probe;
a second substrate disposed on the first ground plane of the stripline; and
a patch antenna disposed on the second substrate and spaced apart from the stripline,
wherein a signal injected into the signal line generates electromagnetic (EM) emissions from the probe, wherein the EM emissions electromagnetically couple to the patch antenna for transmission thereby.

12. The antenna of claim 11 wherein the probe comprises a conductive pad connected to a conductive via formed in the first substrate, the conductive via connected to the signal line.

13. The antenna of claim 12 wherein the conductive pad is approximately coplanar with the first ground plane.

14. The antenna of claim 11 wherein the stripline further comprises a substrate integrated waveguide (SIW) cavity disposed in the first substrate.

15. The antenna of claim 14 wherein the SIW cavity comprises a plurality of vias disposed in the first substrate and arranged about the cut-out portion of the first ground plane.

16. The antenna of claim 11 wherein the signal line is substantially equidistant from the first and second ground planes.

17. The antenna of claim 11 wherein the first substrate is a ceramic material.

18. The antenna of claim 11 wherein the second substrate is a ceramic material.

19. An antenna comprising:
a first substrate;
a second substrate spaced apart from the first substrate;
a metal layer disposed between the first substrate and the second substrate, the metal layer having an open region;
a signal line disposed within the first substrate;
an electromagnetic (EM) probe disposed within the first substrate and connected to the signal line, the EM probe aligned with the open region; and
a patch antenna disposed on the second substrate and spaced apart and electrically disconnected from the signal line.

20. The antenna of claim 19 wherein the first substrate further comprises a dielectric resonator cavity.

21. The antenna of claim 20 wherein the dielectric resonator cavity comprises an SIW cavity defined by a plurality of vias disposed in the first substrate and arranged about the open region of the metal layer.

22. The antenna of claim 19 the patch antenna comprises one or more conductive strips.
